(19) United States
(12) Patent Application Publication
(10) Pub. No.: US 2025/0244776 A1
(43) Pub. Date: Jul. 31, 2025

(54) CONTROL METHOD, CONTROL DEVICE, AND NON-TRANSITORY COMPUTER READABLE STORAGE MEDIUM

(71) Applicant: Panasonic Intellectual Property Management Co., Ltd., Osaka (JP)

(72) Inventor: Atsuyoshi KITA, Osaka (JP)

(21) Appl. No.: 19/184,161

(22) Filed: Apr. 21, 2025

Related U.S. Application Data
(63) Continuation of application No. PCT/JP2023/037852, filed on Oct. 19, 2023.
(60) Provisional application No. 63/419,783, filed on Oct. 27, 2022.

(30) Foreign Application Priority Data
Sep. 26, 2023 (JP) 2023-163350

(51) Int. Cl. G05D 1/698; G05D 105/28; G05D 107/60

(52) U.S. Cl. CPC G05D 1/6987; G05D 2105/28; G05D 2107/63; G05D 2107/65

(57) ABSTRACT

A control method in a control device that controls movement of a plurality of moving bodies includes: moving the plurality of moving bodies in accordance with movement plans that have been predetermined and defining one or more passageways where each of the plurality of moving bodies passes from a departure place to a destination; acquiring an actual delay time that is a delay time of each of the plurality of moving bodies, the delay time being generated in each of the one or more passageways; updating a model representing a length of the delay time defined for each of the one or more passageways using the actual delay time in a corresponding passageway among the one or more passageways; acquiring a current location of each of the plurality of moving bodies; and updating each of the movement plans based on the updated model, the destination, and the current location.

### FIELD OF INVENTION

The present disclosure relates to a technique that controls the movement of a plurality of moving bodies.

### BACKGROUND ART

In recent years, a technique that controls the movement of a plurality of moving bodies is known. This technique has a problem that passageways through which the moving bodies pass are planned so that the plurality of moving bodies can efficiently move without collision. In order to solve this problem, for example, Patent Literature 1 discloses that a section travel route constituting a part of the travel route is set so that an automatic carrier device does not interfere with other automatic carrier devices on the travel route.

However, Patent Literature 1 does not disclose that on the premise that the automatic carrier device interferes with other automatic carrier devices while traveling along a preset travel route, the travel route is set again based on a delay time actually generated in each section of the travel route due to the interference. Therefore, there arises a problem that the automatic carrier device cannot be efficiently moved when a deviation occurs between a scheduled delay time and an actual delay time.
Patent Literature 1: JP 2022-183002 A

### SUMMARY OF THE INVENTION

The present disclosure has been made to solve such a problem, and an object of the present disclosure is to provide a technique capable of efficiently moving a moving body to a destination even when a deviation occurs between a scheduled delay time and an actual delay time.

A control method according to one aspect of the present disclosure is a control method in a control device that controls movement of a plurality of moving bodies, the control method including moving the plurality of moving bodies in accordance with movement plans that have been predetermined, defining, in the movement plans, one or more passageways where each of the plurality of moving bodies passes from a departure place to a destination, acquiring an actual delay time that is a delay time of each of the plurality of moving bodies, the delay time being generated in each of the one or more passageways, updating a model representing a length of the delay time defined for each of the one or more passageways using the actual delay time in a corresponding passageway among the one or more passageways, acquiring a current location of each of the plurality of moving bodies, and updating each of the movement plans based on the updated model, the destination, and the current location.

### BRIEF DESCRIPTION OF THE DRAWINGS

FIG. 1 is an overall configuration diagram of a control system.

FIG. 2 is a flowchart illustrating one example of processing executed in carrier control.

FIG. 3 is a diagram showing one example of a non-grid graph used in an experiment for comparing a planning method of the present disclosure with a conventional planning method.

FIG. 4 is a diagram illustrating one example of a comparison result of probabilities of collision between robots.

### DETAILED DESCRIPTION

### (Knowledge Underlying Present Disclosure)

In recent years, against the background of an increase in the demand for home delivery, a labor shortage in the delivery field, and the like, development of a service for causing a plurality of robots to carry objects in an office building or the like has been advanced. In this service, currently, a plurality of robots is remotely monitored, and when the robots are about to collide with each other, a remote operation for stopping any robot is performed. Further, when the plurality of robots collides with each other, the remote control is performed to move the plurality of robots to places where they can pass each other.

However, the load and cost of such work of remote monitoring and remote operation increase as the number of robots increases. Therefore, the above-described service has a problem that a passageway where each of the plurality of robots passes is planned so that the plurality of robots can efficiently move without collision. In order to solve this problem, for example, Patent Literature 1 discloses that a section travel route constituting a part of the travel route is set so that an automatic carrier device does not interfere with other automatic carrier devices on the travel route.

Further, in a place, such as an office building, where pedestrians and various types of robots coexist, even if passageways where the robots pass are planned so that the robots under the same service do not collide with each other, the robots may collide with obstacles such as pedestrians and robots under other services. For this reason, in a case where the plurality of robots is moved in such a place, there arises a problem that the passageways where each robot passes are planned in order to avoid obstacles in consideration of a deceleration and a temporary stop time for each robot. In a case where the robots are caused to use an elevator in an office building or the like, the passageways where the robots pass are planned in further consideration of time for each robot to wait for the elevator and time for each robot to get on and off the elevator.

However, the time for the robot to decelerate and temporarily stop in order to avoid an obstacle, the time for the robot to wait for the elevator, and the time for the robot to get on and off the elevator are not constant. For this reason, in a place where pedestrians and a wide variety of robots coexist, the passageways where each robot passes have to be planned based on the delay time assuming that the delay time stochastically fluctuates in each passageway.

Patent Literature 1 does not disclose that on the premise that an automatic carrier device interferes with another automatic carrier device while traveling along a preset travel route, the travel route is set based on a delay time actually generated in each section of the travel route due to the interference. Therefore, there arises a problem that the automatic carrier device cannot be efficiently moved when a deviation occurs between a scheduled delay time and an actual delay time.

Therefore, the present inventor has intensively studied a technique capable of efficiently moving a moving body to a destination even when a deviation occurs between the scheduled delay time and the actual delay time, and has arrived at each aspect of the present disclosure described below.
(1) A control method according to one aspect of the present disclosure is a control method in a control device that controls movement of a plurality of moving bodies, the control method including: moving the plurality of moving bodies in accordance with movement plans that have been predetermined, the movement plans defining one or more passageways where each of the plurality of moving bodies passes from a departure place to a destination; acquiring an actual delay time that is a delay time of each of the plurality of moving bodies, the delay time being generated in each of the one or more passageways; updating a model representing a length of the delay time defined for each of the one or more passageways using the actual delay time in a corresponding passageway among the one or more passageways; acquiring a current location of each of the plurality of moving bodies; and updating each of the movement plans based on the updated model, the destination, and the current location.

In this configuration, the model representing the length of the delay time defined for each of the one or more passageways is updated using the actual delay time that is the delay time of each of the plurality of moving bodies, the delay time being generated in each of the one or more passageways. Then, the movement plan is updated based on the current location and the destination of each of the plurality of moving bodies, and the updated model. In the movement plan, the one or more passageways where each of the plurality of moving bodies passes from the departure place to the destination are defined.

Therefore, with this configuration, the movement plans of the plurality of moving bodies can be updated in consideration of the delay time generated when each of the plurality of moving bodies actually passes through the passageway. As a result, even when a deviation occurs between the scheduled delay time and the actual delay time, each moving body can be efficiently moved to the destination.
(2) In the control method described in (1), the movement plans may be updated when any one of the plurality of moving bodies reaches the destination.

In the present configuration, since the movement plans are updated when any one of the plurality of moving bodies reaches the destination, the movement plans of one or more moving bodies that have not reached their destinations can be updated.
(3) In the control method described in (1), the movement plans may be updated when any one of the plurality of moving bodies has passed through any one of the one or more passageways.

In this configuration, since the movement plans are updated when any one of the plurality of moving bodies finishes passing through any one of the one or more passageways, the movement plans of one or more moving bodies that are passing through any passageways during the updating can be updated.
(4) In the control method described in (1), the movement plans may be periodically updated during movement of the plurality of moving bodies.

In the present configuration, since the movement plans are periodically updated during the movement of the plurality of moving bodies, the movement plans of the plurality of moving bodies can be updated at the same timing.
(5) In the control method described in any one of (1) to (4), the movement plans each are updated to define the one or more passageways where each of the plurality of moving bodies passes from a passageway next to a passageway including the current location to the destination so that the plurality of moving bodies does not collide with each other.

According to the present configuration, after each of the plurality of moving bodies passes through the passageway including the current location, the one or more passageways where each of the plurality of moving bodies passes to the destination can be updated to prevent a collision between the plurality of moving bodies.
(6) In the control method described in any one of (1) to (4), in the movement plans, a scheduled time at which each of the plurality of moving bodies enters each of the one or more passageways may be further defined.

According to the present configuration, the timing at which each of the plurality of moving bodies enters a corresponding passageway can be updated based on the delay time of each of the plurality of moving bodies, the delay time being actually generated in each of the one or more passageways.
(7) In the control method described in (1), the model may be a probability distribution of the delay time.

In this configuration, the probability distribution of the delay time is defined for each of the one or more passageways. The probability distribution is updated using the actual delay time that is the delay time of each of the plurality of moving bodies, the delay time being generated in each of the one or more passageways, and is used for updating the movement plans of the plurality of moving bodies. Therefore, the movement plan of each of the plurality of moving bodies can be updated in consideration of the delay time generated when each of the plurality of moving bodies actually passes through the passageway. As a result, even when a deviation occurs between the scheduled delay time and the actual delay time, each moving body can be efficiently moved to the destination.
(8) A control device according to another aspect of the present disclosure is a control device that controls movement of a plurality of moving bodies, the control device including a processor, wherein the processor executes: moving the plurality of moving bodies in accordance with movement plans that have been predetermined, the movement plans defining one or more passageways where each of the plurality of moving bodies passes from a departure place to a destination; acquiring an actual delay time that is a delay time of each of the plurality of moving bodies, the delay time being generated in each of the one or more passageways; updating a model representing a length of the delay time defined for each of the one or more passageways using the actual delay time in a corresponding passageway among the one or more passageways; acquiring a current location of each of the plurality of moving bodies; and updating each of the movement plans based on the updated model, the destination, and the current location.

According to this configuration, the same operation and effect as those of the control method described in (1) can be obtained.
(9) A non-transitory computer readable storage medium according to still another aspect of the present disclosure is a non-transitory computer readable storage medium storing a program of a control device that controls movement of a plurality of moving bodies, the program causing the control device to perform operations including: moving the plurality of moving bodies in accordance with movement plans that have been predetermined, the movement plans defining one or more passageways where each of the plurality of moving bodies passes from a departure place to a destination; acquiring an actual delay time that is a delay time of each of the plurality of moving bodies, the delay time being generated in each of the one or more passageways; updating a model representing a length of the delay time defined for each of the one or more passageways using the actual delay time in a corresponding passageway among the one or more passageways; acquiring a current location of each of the plurality of moving bodies; and updating each of the movement plans based on the updated model, the destination, and the current location.

According to this configuration, the same operation and effect as those of the control method described in (1) can be obtained.

The present disclosure can also be implemented as a control system that operates using such this program. It is needless to say that such a computer program can be distributed via a computer-readable non-transitory recording medium such as a CD-ROM or via a communication network such as the Internet.

Note that all embodiments described below describe specific examples of the present disclosure. Numerical values, shapes, constituents, steps, order of steps, and the like described in the embodiments below are merely examples, and are not intended to limit the present disclosure. Further, a constituent element not described in an independent claim representing a highest concept among constituent elements in the embodiments below is described as an optional constituent element. In all the embodiments, respective contents can be combined.

### EMBODIMENTS

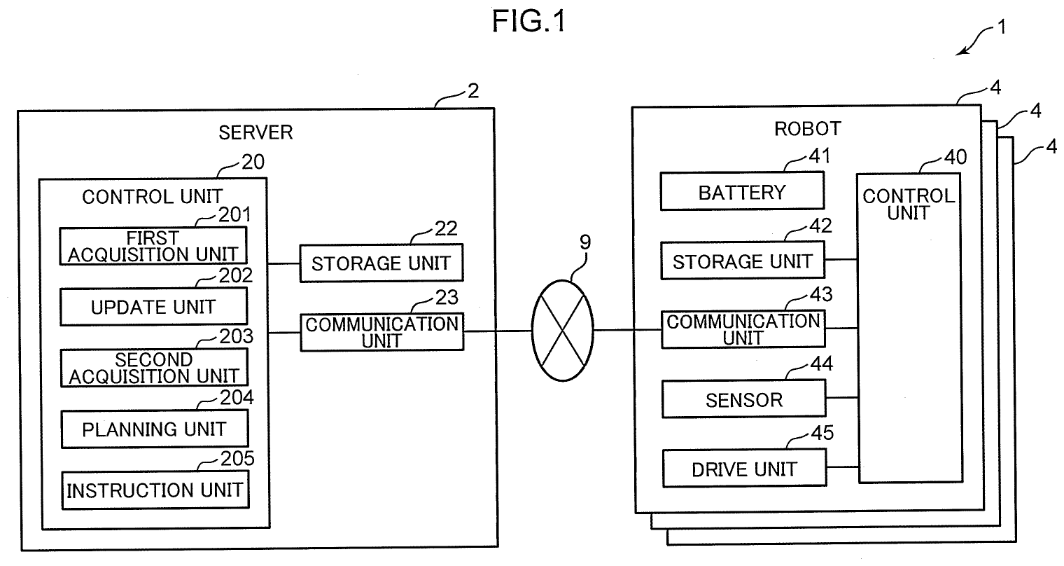

Hereinafter, a control system according to an embodiment of the present disclosure will be described with reference to the drawings. FIG. 1 is an overall configuration diagram of a control system 1. The control system 1 is a system that controls the movement of a plurality of robots 4.

For example, the control system 1 is applicable to a system that causes the plurality of robots 4 to carry documents, fixtures, dishes, and the like in a place, such as an office building, a nursing care facility, and a family restaurant, where pedestrians and a wide variety of robots coexist. Further, the control system 1 is applicable to a system that causes the plurality of robots 4 to carry cargo, parts, and the like in a place, such as a warehouse and a factory, where the number and width of passageways are limited. The robot 4 is not limited to the robot that carries an object as described above, and may be a moving body that autonomously travels. The present embodiment describes an example in which the control system 1 is applied to a system that causes the plurality of robots 4 to carry objects such as documents and fixtures in an office building.

Specifically, as illustrated in FIG. 1, the control system 1 includes the plurality of robots 4 and a server 2 (control device).

The robot 4 carries an object while autonomously moving based on task information received from the server 2 using charging power charged in a battery 41. Specifically, the robot 4 includes the battery 41, a storage unit 42, a communication unit 43, a sensor 44, a drive unit 45, and a control unit 40.

The battery 41 includes a rechargeable secondary battery. The battery 41 is charged with power supplied from a charging device, not illustrated, via a charging cable. The battery 41 supplies the charged power to each unit of the robot 4.

The storage unit 42 includes a non-volatile memory that stores a predetermined control program and a memory such as a random access memory (RAM) that temporarily stores information. The storage unit 42 stores various types of information regarding the control of the robot 4 under the control by the control unit 40. The storage unit 42 may further store various types of information regarding the control of the robot 4 in advance.

The information regarding the control of the robot 4 includes map information about the inside of an office building where the robot 4 moves and task information instructing the robot 4 to execute a task of carrying an object.

The map information includes information about a plurality of rooms and passageways provided indoors. The information regarding the rooms includes identification information about rooms and information indicating positions of the rooms (hereinafter, position information). The position information about rooms is, for example, latitudes and longitudes of the positions where the rooms exist. Note that the present disclosure is not limited thereto, and the position information about rooms may include altitudes of the positions where the rooms exist. The information regarding passageways includes identification information about the passageways, lengths and widths of the passageways, and times required for the robot 4 to pass through the passageways without avoiding obstacles (hereinafter, passageway required time).

The task information includes identification information about objects to be carried, departure places and destinations of the objects to be carried by the robot 4, and a movement plan. The movement plan includes identification information about one or more passageways through which the robot 4 passes between a departure place and a destination, and scheduled time at which the robot 4 enters each of the one or more passageways.

The communication unit 43 includes a communication interface circuit for communicating with an external device such as the server 2. The communication unit 43 outputs information received from the external device to the control unit 40, and transmits information input from the control unit 40 to the external device.

The sensor 44 includes, for example, a global positioning system (GPS) sensor, a light detection and ranging (LiDAR) sensor, an image sensor, a speed sensor, an acceleration sensor, a timer, and/or a weight sensor. The sensor 44 detects a current location, moving direction, moving distance, and moving time of the robot 4, and placement of an object on an object pallet, not illustrated.

The drive unit 45 includes a drive motor, not illustrated, that controls the orientation and rotation of a plurality of wheels provided on a bottom surface of a body of the robot 4. The drive unit 45 moves or stops the robot 4 in a designated direction under the control by the control unit 40.

The control unit 40 includes a processor such as a central processing unit (CPU). The control unit 40 controls each unit of the robot 4 by executing a control program stored in the storage unit 42.

For example, when the communication unit 43 receives map information from the server 2, the control unit 40 stores the map information in the storage unit 42. When the communication unit 43 receives task information from the server 2, the control unit 40 temporarily stores the task information in the storage unit 42. The control unit 40 controls the drive unit 45 so that the drive unit 45 causes the robot 4 to carry an object indicated by the task information based on the task information stored in the storage unit 42, the map information, and the information detected by the sensor 44.

Specifically, the control unit 40 moves the robot 4 to a departure place indicated by the task information. The control unit 40 causes a picking mechanism, not illustrated, to acquire the object indicated by the task information, and places the acquired object on the object pallet, not illustrated. Alternatively, the control unit 40 causes a speaker, not illustrated, to output a voice requesting placement of the object indicated by the task information onto the object pallet, thereby requesting a person existing in the vicinity to place the object onto the object pallet. Note that the present disclosure is not limited thereto, and the control unit 40 may request placement of an object onto the object pallet by controlling a display, not illustrated, and outputting, to the display, a message for requesting placement of the object onto the object pallet.

When the sensor 44 detects the placement of the object onto the object pallet, the control unit 40 controls the drive unit 45 so that the robot 4 passes through each of the one or more passageways in order of scheduled time, based on the movement plan included in the task information. As a result, the control unit 40 moves the robot 4 to the destination indicated by the task information. Note that when the sensor 44 detects an obstacle while the robot 4 is moving to the destination, the control unit 40 temporarily stops and/or decelerates the robot 4 until the sensor 44 no longer detects the obstacle.

When the robot 4 arrives at the destination, the control unit 40 causes the speaker, not illustrated, to output a voice requesting the acquisition of the object, thereby requesting the person existing in the vicinity to acquire the object placed on the object pallet. Note that the present disclosure is not limited thereto, and the control unit 40 may request acquisition of the object placed onto the object pallet by controlling the display, not illustrated, and outputting, to the display, a message for requesting the acquisition of the object.

The server 2 communicates with the plurality of robots 4 via a network 9 to perform control (hereinafter, carrier control) of causing the plurality of robots 4 to carry objects. Specifically, the server 2 includes a storage unit 22, a communication unit 23, and a control unit 20.

The storage unit 22 includes a non-volatile memory that stores a predetermined control program and a memory such as a RAM that temporarily stores information. The storage unit 22 stores various types of information regarding the carrier control.

In the storage unit 22, for example, map information to be stored in the storage unit 42 of each robot 4 is stored in advance.

In a case where the sensor 44 detects an obstacle when the robot 4 passes through each passageway, the robot 4 temporarily stops and/or decelerates to avoid the obstacle. As a result, a delay following the gamma distribution may occur in each passageway. As described above, in a case where a delay occurs when the robot 4 passes through a certain passageway, the time required for the robot 4 to pass through the passageway is obtained by adding the required time for the passageway included in the map information and the time of the delay (hereinafter, the delay time). In the storage unit 22, information indicating a probability distribution (a model representing the length of the delay time) of the delay time defined for each of the one or more passageways is stored. The probability distribution is indicated by the map information. The information indicating the probability distribution of the delay time includes a shape parameter and a scale parameter of a gamma distribution.

The communication unit 23 includes a communication interface circuit for communicating with an external device such as the robot 4. The communication unit 23 outputs information received from the external device to the control unit 20, and transmits the information input from the control unit 20 to the external device.

The control unit 20 includes a microcomputer (computer) including a CPU, and the like. The control unit 20 controls each unit of the server 2 by executing the control program stored in the storage unit 22.

For example, the control unit 20 causes the communication unit 23 to transmit the map information stored in the storage unit 22 to the plurality of robots 4. When acquiring the map information via the communication unit 43, the control unit 40 of the robot 4 stores the acquired map information in the storage unit 42.

Further, the control unit 20 executes the control program stored in the storage unit 22 to function as a first acquisition unit 201, an update unit 202, a second acquisition unit 203, a planning unit 204, and an instruction unit 205.

The first acquisition unit 201 acquires the delay time (hereinafter, an actual delay time) of each of the plurality of robots 4, the delay time being generated in each of the one or more passageways.

Specifically, every time the robot 4 passes through each of the one or more passageways after starting to move in accordance with the movement plan included in the task information, the control unit 40 (FIG. 1) of the robot 4 acquires the moving time of the robot 4 in each passageway, the moving time being detected by the sensor 44 (FIG. 1), as the time required for passing through each passageway. The control unit 40 calculates, as an actual delay time, a result obtained by subtracting the required time for each passageway included in the map information stored in the storage unit 42 (FIG. 1) from the acquired time required for passing each passageway. The control unit 40 causes the communication unit 43 to transmit information (hereinafter, delay time information) including the calculated actual delay time generated for each passageway and the identification information about each passageway included in the map information to the server 2. The first acquisition unit 201 acquires the delay time information received by the communication unit 23 from each of the plurality of robots 4. As a result, the first acquisition unit 201 acquires the actual delay time of each of the plurality of robots 4. The actual delay time is generated in the passageway indicated by the identification information included in the delay time information.

The update unit 202 updates the probability distribution of the delay time defined for each of the one or more passageways using the actual delay time in a corresponding passageway.

Specifically, the delay time x to Gamma (a, b) according to the gamma distribution can be generated by temporarily stopping and/or decelerating the robot 4 to avoid an obstacle when the robot 4 passes through each passageway. Symbol a represents a shape parameter of the gamma distribution of the delay time x defined for each passageway. Symbol b represents a scale parameter of the gamma distribution of the delay time x defined for each passageway.

A prior distribution of the shape parameter a and the scale parameter b of the gamma distribution of the delay time x defined for a certain passageway is denoted by P (a, b), and an actual delay time generated when the robot 4 passes through this passageway for the i-th time is denoted by xi. In this case, a posterior distribution P (a, b|x) of the shape parameter a and the scale parameter b can be expressed by the following Formula (1) using Bayesian inference.

$$\begin{matrix}[ Mathematical formula 1 ] & \\ P ( a , b \vert x ) ∝ {{\prod }_{i = 1}}^{m} Gamma ( {x}_{i} \vert a , b ) * p ( a , b ) & ( 1 )\end{matrix}$$

Every time the first acquisition unit 201 acquires an actual delay time xᵢ generated in a certain passageway, the update unit 202 substitutes the actual delay times xᵢ (i=1, . . . , m) generated in this passageway, the actual delay times being acquired by the first acquisition unit 201 up to the present, and the prior distribution P (a, b) of the predetermined shape parameter a and scale parameter b into the formula (1), thereby acquiring a posterior distribution P (a, b|x).

The update unit 202 calculates a maximum a posteriori (MAP) estimation value aₘₐₚ of the shape parameter a and a MAP estimation value bₘₐₚ of the scale parameter b with the Newton method by differentiating a logarithm of the acquired posterior distribution P (a, b|x) and sets it to 0. The MAP estimation value aₘₐₚ of the shape parameter a and the MAP estimation value bₘₐₚ of the scale parameter b are respectively the shape parameter a and the scale parameter b that maximize the peak values of the posterior distribution P (a, b|x).

The update unit 202 sets, as a probability distribution of the updated delay time x, a Gaussian distribution having the calculated MAP estimation value aₘₐₚ as the shape parameter a and the calculated MAP estimation value bₘₐₚ as the scale parameter b. Specifically, the update unit 202 rewrites the shape parameter a and the scale parameter b included in the information indicating the probability distribution of the delay time stored in the storage unit 22 with the calculated MAP estimation value aₘₐₚ and MAP estimation value bₘₐₚ.

The second acquisition unit 203 acquires a current location of each of the plurality of robots 4

Specifically, after the robot 4 starts moving in accordance with the movement plan included in the task information, the control unit 40 (FIG. 1) of the robot 4 periodically acquires the current location of the robot 4 detected by the sensor 44 (FIG. 1). The control unit 40 controls the communication unit 43 every time acquiring the current location of the robot 4, and transmits the acquired current location of the robot 4 to the server 2. The second acquisition unit 203 acquires the current location each time the communication unit 23 receives the current location from each of the plurality of robots 4.

The planning unit 204 plans the movement route of each of the plurality of robots 4 based on information (hereinafter, carrying instruction information) for instructing each of the plurality of robots 4 to carry an object and the probability distribution of the delay time x defined for each of one or more passageways.

Specifically, the planning unit 204 acquires the carrying instruction information for each robot 4, the information being received by the communication unit 23, from the external device. Alternatively, in a case where the server 2 includes an operation device such as a keyboard, not illustrated, the planning unit 204 may acquire the carrying instruction information for each robot 4, the information being input using the operation device.

The carrying instruction information includes identification information about the robot 4 that carries the object, identification information about the object to be carried by the robot 4, and a departure place and destination of the object carried by the robot 4. The departure place of the object carried by the robot 4 is a room where the robot 4 acquires the object. Further, the destination of the object carried by the robot 4 is a room to which the object is to be carried.

The planning unit 204 refers to the map information stored in the storage unit 22 and generates a connected bidirectional non-grid graph G=(V,E) including a set V of a plurality of vertices v corresponding to the plurality of rooms provided indoors and a set E of a plurality of sides e corresponding to the one or more passageways provided indoors. It is assumed that the length of each side e of the non-grid graph G=(V,E) is equal to the required time of the passageway corresponding to each side e.

Using the non-grid graph G=(V,E), the planning unit 204 determines one or more sides e through which each of the plurality of robots 4 passes from a vertex v corresponding to a departure place sa to a vertex v corresponding to a destination gₐ, and a scheduled time t at which each of the plurality of robots 4 enters each of the one or more sides e based on a Stochastic Travel Time-Conflict-Based Search (STT-CBS) algorithm disclosed in Document D1 (STT-CBS: A Conflict-Based Search Algorithm for Multi-Agent Path Finding with Stochastic Travel Times. arXiv preprint arXiv: 2004.08025. (2021) https://doi.org/10.48550/ARXIV.2004.08025).

That is, the planning unit 204 calculates the probability of collision between the robots at each side e using the Monte Carlo method on the assumption that a delay of a certain time occurs at each vertex v of the non-grid graph G=(V,E) and that a delay time according to the probability distribution of the delay time x defined for the passageway corresponding to each side e is generated at each side e. The planning unit 204 determines the one or more sides e through which each of the plurality of robots 4 passes from the vertex v corresponding to the departure place sₐ to the vertex v corresponding to the destination gₐ, and the scheduled time t at which each of the plurality of robots 4 enters each of the one or more sides e so that the probability of collision between the robots at each side e is smaller than or equal to a predetermined value.

The planning unit 204 defines, as the movement plan of each of the plurality of robots 4, the identification information about the one or more passageways corresponding to the one or more sides e and the scheduled time t at which the robot 4 enters each of the one or more sides e.

The instruction unit 205 causes the communication unit 23 to transmit information indicating various types of instructions to each of the plurality of robots 4.

For example, when the planning unit 204 plans the travel route of each of the plurality of robots 4, the instruction unit 205 transmits task information for instructing each of the plurality of robots 4 to execute a task of carrying an object.

Specifically, the instruction unit 205 generates task information including the identification information about an object to be carried, the departure place and destination of each robot 4, and the movement plan of each robot 4 defined by the planning unit 204, which are indicated by the carrying instruction information for each robot 4. The instruction unit 205 causes the communication unit 23 to transmit the task information to each robot 4.

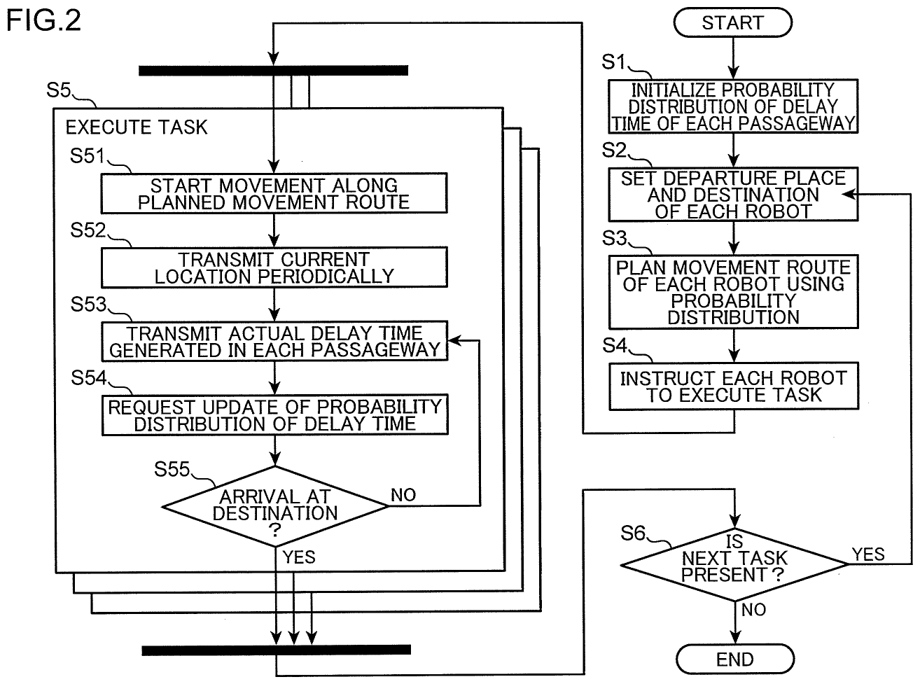

Next, a flow of the carrier control will be described. The control unit 20 starts the carrier control at any timing such as when the server 2 is activated. FIG. 2 is a flowchart illustrating one example of processing executed in the carrier control.

When the carrier control is started, the planning unit 204 initializes the probability distribution of the delay time defined for each of the one or more passageways (step S1).

Specifically, in step S1, the planning unit 204 acquires, from the storage unit 22, information indicating the probability distribution of the delay time defined for each of the one or more passageways. Further, the planning unit 204 refers to the map information stored in the storage unit 22 and generates the connected bidirectional non-grid graph G=(V,E) including the set V of the plurality of vertices v corresponding to the plurality of rooms and the set E of the plurality of sides e corresponding to the one or more passageways.

Next, the planning unit 204 sets a departure place and destination of each robot 4 (step S2).

Specifically, every time the communication unit 23 receives the carrying instruction information for each robot 4 from the external device, the planning unit 204 temporarily stores, in the storage unit 22, the carrying instruction information for each robot 4 received by the communication unit 23. Alternatively, in a case where the server 2 includes an operation device such as a keyboard, not illustrated, every time the carrying instruction information for each robot 4 is input using the operation device, the planning unit 204 temporarily stores the input carrying instruction information for each robot 4 in the storage unit 22.

In a case where a plurality of pieces of carrying instruction information for each robot 4 is stored in the storage unit 22, the planning unit 204 sets, as the departure place and destination of each robot 4, a departure place and destination of the object carried by the robot 4, the departure place and destination being included in the oldest carrying instruction information stored in the storage unit 22.

Next, the planning unit 204 plans the movement route of each of the plurality of robots 4 using the probability distribution of the delay time defined for each of the one or more passageways, the probability distribution being initialized in step S1 (step S3).

Specifically, in step S3, the planning unit 204 uses the non-grid graph G=(V,E) generated in step S1 and the probability distribution of the delay time defined for the passageway corresponding to each side e indicated by the information acquired in step S1. The planning unit 204 determines one or more sides e through which each of the plurality of robots 4 passes from the vertex v corresponding to the departure place set in step S2 to the vertex v corresponding to the destination set in step S2, and the scheduled time t at which each robot 4 enters each of the one or more sides e based on the STT-CBS algorithm. The planning unit 204 defines, as the movement plan of each of the plurality of robots 4, the identification information about the one or more passageways corresponding to the one or more sides e and the scheduled time t at which the robot 4 enters each of the one or more sides e.

Next, the instruction unit 205 instructs each of the plurality of robots 4 to execute a task of carrying an object by transmitting task information instructing the execution of the task of carrying an object to each robot 4 (step S4).

As a result, each of the plurality of robots 4 starts execution of the task of carrying the object indicated by the task information received by the communication unit 43 (step S5). Specifically, when the communication unit 43 receives the task information from the server 2, the control unit 40 temporarily stores the task information in the storage unit 42. The control unit 40 then controls the drive unit 45 so that the drive unit 45 causes the robot 4 to carry the object instructed by the task information based on the task information stored in the storage unit 42, the map information, and the information detected by the sensor 44.

When the robot 4 starts executing the task and starts moving along the planned movement route (step S51), the control unit 40 periodically causes the communication unit 43 to transmit the current location of the robot 4 detected by the sensor 44 to the server 2 (step S52). The movement of the robot 4 along the planned movement route indicates that, under the control by the control unit 40, the robot 4 moves from the departure place indicated by the task information to the destination indicated by the task information while passing through the one or more passageways indicated by the movement plan included in the task information in accordance with scheduled times indicated by the movement plan.

Every time the robot 4 passes through each passageway, the control unit 40 causes the communication unit 43 to transmit the actual delay time generated in each passageway to the server 2 (step S53). Specifically, in step S53, every time the robot 4 passes through each passageway, the control unit 40 calculates the actual delay time generated in each passageway as described above, and causes the communication unit 43 to transmit the delay time information including the actual delay time and identification information about each passageway included in the map information to the server 2. As a result, the first acquisition unit 201 of the server 2 acquires the actual delay time generated in the passageway indicated by the identification information included in the delay time information received from each robot 4 by the communication unit 23.

When transmitting the actual delay time generated in a certain passageway in step S53, the control unit 40 causes the communication unit 43 to transmit, to the server 2, information (hereinafter, update request information) requesting update of the probability distribution of the delay time defined for the passageway (step S54). As a result, when the communication unit 23 of the server 2 receives the update request information, the update unit 202 updates the probability distribution of the delay time indicated by the update request information using the actual delay time acquired by the first acquisition unit 201 by the latest execution of step S53.

Next, when the current location of the robot 4, the current location being detected by the sensor 44, is not the destination of the robot 4, the control unit 40 determines that the robot 4 has not arrived at the destination (NO in step S55). In this case, processing in and after step S53 is executed.

On the other hand, when the current location of the robot 4, the current location being detected by the sensor 44, is the destination of the robot 4, the control unit 40 determines that the robot 4 has arrived at the destination (YES in step S55). In this case, the control unit 40 determines that the task of carrying the object by the robot 4 has been completed, and transmits information indicating that the robot 4 has completed the task of carrying the object (hereinafter, completion information) to the server 2. The completion information includes identification information about the robot 4 that has completed the task of carrying the object and the identification information about the object.

In the server 2, when the communication unit 23 receives the completion information, the planning unit 204 determines whether there exists a next task to be executed by the robot 4 corresponding to the identification information included in the completion information (step S6).

Specifically, in step S6, the planning unit 204 deletes, from the storage unit 22, the carrying instruction information including the identification information about the robot 4 and identification information about the object matching the identification information about the robot 4 and identification information about the object included in the completion information.

When the storage unit 22 has the carrying instruction information including the identification information about the robot 4 that matches the identification information about the robot 4 included in the completion information, the planning unit 204 determines that there exists a next task to be executed by the robot 4 corresponding to the identification information included in the completion information (YES in step S6).

In this case (YES in step S6), the processing in and after step S2 is executed. However, in step S2, the planning unit 204 sets the end point of the passageway including the current location of the robot in operation most recently acquired by the second acquisition unit 203, as the departure place of the robot 4 (hereinafter, the robot in operation) that is executing a task different from the robot 4 about which the next task is determined to exist in step S6.

As a result, in next step S3, the planning unit 204 updates the movement plan of each of the plurality of robots 4 based on the probability distribution updated by the execution of step S54, the destination set in the first step S2, and the current location acquired most recently by the second acquisition unit 203.

Note that, in step S3, the planning unit 204 defines, as the movement plan of the robot in operation, the one or more passageways through which the robot in operation passes from a passageway next to the passageway including the current location to the destination, and the scheduled time at which the robot in operation enters each of the one or more passageways using the updated probability distribution. Therefore, it is possible to prevent the robot in operation from returning from the passageway currently passing to the departure place where the execution of the task is started, and it is possible to move the robot in operation to the end point of the passageway including the current location, which is a newly set departure place, without changing the passageway.

On the other hand, it is assumed that the storage unit 22 has no carrying instruction information including the identification information about the robot 4 that matches the identification information about the robot 4 included in the completion information. In this case, the planning unit 204 determines that there exists no next task to be executed by the robot 4 corresponding to the identification information included in the completion information (NO in step S6), and ends the control of the robot 4. Note that, also in this case (NO in step S6), similarly to the case where there exists a next task to be executed by the robot 4 corresponding to the identification information included in the completion information (YES in step S6), the processing in and after step S2 may be executed.

In such a manner, in the configuration of the present embodiment, the probability distribution of the delay time defined for each of the one or more passageways is updated using the actual delay time that is the delay time of each of the plurality of robots 4, the delay time being generated in each of the one or more passageways. Then, using the updated probability distribution, the movement plan, in which the one or more passageways through which each of the plurality of robots 4 passes from the departure place to the destination is defined, is updated. Therefore, this configuration makes it possible to update the movement plan of each of the plurality of robots 4 in consideration of the delay time generated when each of the plurality of robots 4 actually passes through the passageways. As a result, even when a deviation occurs between the scheduled delay time and the actual delay time, each robot 4 can be efficiently moved to the destination.

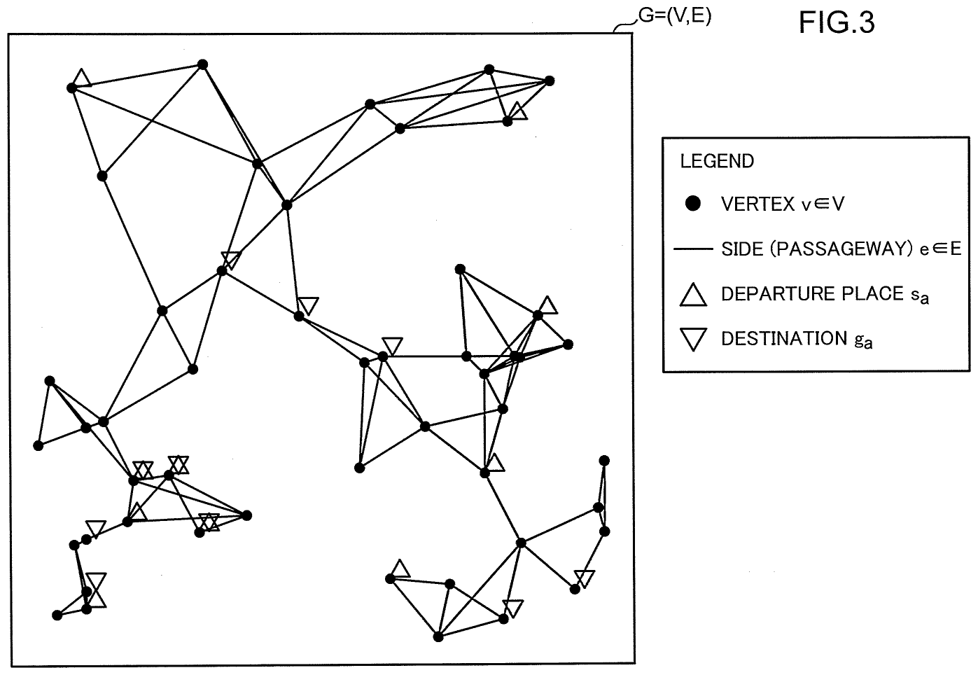

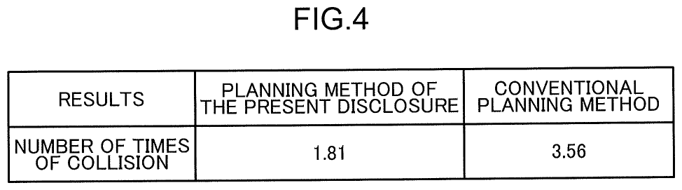

The following describes one example of a result of an experiment for comparing the method for planning and updating the movement routes of the plurality of robots 4 described in the above embodiment (hereinafter, the planning method of the present disclosure) with the conventional method for planning the movement routes of the plurality of robots 4 (hereinafter, the conventional planning method) with reference to FIGS. 3 and 4. FIG. 3 is a diagram illustrating one example of the non-grid graph G=(V,E) used in the experiment for comparing the planning method of the present disclosure with the conventional planning method. FIG. 4 is a diagram illustrating one example of a comparison result of probabilities of collision between robots. Note that the conventional planning method is different from the planning method of the present disclosure in that the probability distribution of the delay time defined for each of the one or more passageways is not updated and that the movement routes of the plurality of robots 4 are not updated after being planned.

Specifically, in the non-grid graph G=(V,E) having 50 vertices v illustrated in FIG. 3, a first simulation is performed. In this simulation, each of ten robots 4 is caused to execute 100 tasks of moving from the vertex v corresponding to the departure place sₐ to the vertex v corresponding to the destination gₐ, and the movement routes of the ten robots 4 are planned and updated with the planning method of the present disclosure. Similarly, in the non-grid graph G=(V,E) illustrated in FIG. 3, a second simulation is performed. In this simulation, each of the ten robots 4 is caused to execute the same 100 tasks as in the first simulation, and the movement routes of the ten robots 4 are planned with the conventional planning method.

As a result, as illustrated in FIG. 4, an average value of the number of times of collision between the robots while the ten robots 4 execute 100 tasks is 1.81 in the planning method of the present disclosure, whereas it is 3.56 in the conventional planning method. As a result, it can be found that the planning method of the present disclosure can reduce the probability of collision between the robots as compared with the conventional planning method.

In the above embodiment, when any one of the plurality of robots 4 reaches the destination, the movement plans of the plurality of robots 4 are updated. However, the timing of updating the movement plans of the plurality of robots 4 is not limited thereto.

For example, when any one of the plurality of robots 4 finishes passing through any one of the one or more passageways, the movement plans of the plurality of robots 4 may be updated.

This configuration can be achieved as described below, for example. Specifically, after step S54 (FIG. 2) is performed in any one of the plurality of robots 4, steps S2 to S4 (FIG. 2) are performed. In step S4, together with the movement plan of each robot 4 defined in step S3 immediately prior to step S4, a command for performing control for replacing the movement plan currently referred to with the movement plan newly received by the communication unit 43 is transmitted to the control unit 40 of each robot 4.

Alternatively, the movement plans of the plurality of robots 4 may be periodically updated during the movement of the plurality of robots 4.

This configuration can be achieved as described below, for example. Specifically, steps S2 to S4 (FIG. 2) are performed every time a predetermined time elapses after step S51 (FIG. 2) is performed in the plurality of robots 4. In step S4 (FIG. 2), together with the movement plan of each robot 4 defined in step S3 immediately prior to step S4, a command for performing control for replacing the movement plan currently referred to with the movement plan newly received by the communication unit 43 is transmitted to the control unit 40 of each robot 4.

The above embodiment has described the example in which the update unit 202 updates the probability distribution of the delay time defined in each passageway using the actual delay time generated in each passageway, and the planning unit 204 plans the movement routes of the plurality of robots 4 based on the probability distribution. However, the model representing the length of the delay time different from the probability distribution of the delay time may be defined for each of the one or more passageways. Accordingly, the update unit 202 may update the model defined for each passageway using the actual delay time generated in each passageway, and the planning unit 204 may plan the movement routes of the plurality of robots 4 based on the model. This configuration can be achieved as described below, for example.

For example, for each of the one or more passageways, the update unit 202 generates, for each of the one or more passageways, a learned model (hereinafter, a delay time model) that has been machine-learned a relationship between information (hereinafter, situation information) indicating a situation at a time when each of the plurality of robots 4 passes through each passageway and delay time (actual delay time) generated in each of the plurality of robots 4 in the past in each passage. When the situation information indicating the situation at the time when the robot 4 passes through the passageway is input, the delay time model generated for a certain passageway outputs the delay time generated when the robot 4 enters the passageway. The situation information includes, for example, at least one of the width and length of the passageway through which the robot 4 passes, the time when the robot 4 enters the passageway, and the number of robots 4 passing through a passageway adjacent to the passageway when the robot 4 enters this passageway.

The update unit 202 stores the delay time model generated for a certain passageway in the storage unit 22 as information indicating the model representing the length of the delay time defined for the passageway. Every time each robot 4 passes through the passageway, the update unit 202 performs the machine learning using the situation information indicating the situation at the time when each robot 4 passes through the passageway and the actual delay time generated in each robot 4 during passing. As a result, the update unit 202 updates the delay time model defined for the passageway, the delay time model being stored in the storage unit 22.

The planning unit 204 generates a delay of a certain time at each vertex v of the non-grid graph G=(V,E), similarly to the above-described embodiment. On the other hand, in each side e, unlike the above-described embodiment, the planning unit 204 generates a delay time, which is output when the situation information indicating the situation at the time when each robot 4 passes through the passageway is input, to the delay time model defined for the passageway corresponding to each side e. As described above, assuming that the delay time is generated at each vertex v and each side e, the planning unit 204 calculates the probability of collision between the robots at each side e using the Monte Carlo method.

The planning unit 204 determines, similarly to the above embodiment, the one or more sides e through which each of the plurality of robots 4 passes from the vertex v corresponding to the departure place sₐ to the vertex v corresponding to the destination gₐ, and the scheduled time t at which each of the plurality of robots 4 enters each of the one or more sides e so that the probability of collision between the robots at each side e is smaller than or equal to a predetermined value. The planning unit 204 defines, as the movement plan of each of the plurality of robots 4, the identification information about the one or more passageways corresponding to the one or more sides e and the scheduled time t at which the robot 4 enters each of the one or more sides e.

The present disclosure is useful for efficiently moving a plurality of robots to destinations in a service for controlling movement of the robots in a place such as an office building where pedestrians and a wide variety of robots coexist.

1. A control method in a control device that controls movement of a plurality of moving bodies, the control method comprising:
moving the plurality of moving bodies in accordance with movement plans that have been predetermined, the movement plans defining one or more passageways where each of the plurality of moving bodies passes from a departure place to a destination;
acquiring an actual delay time that is a delay time of each of the plurality of moving bodies, the delay time being generated in each of the one or more passageways;
updating a model representing a length of the delay time defined for each of the one or more passageways using the actual delay time in a corresponding passageway among the one or more passageways;
acquiring a current location of each of the plurality of moving bodies; and
updating each of the movement plans based on the updated model, the destination, and the current location.

2. The control method according to claim 1, wherein the movement plans are updated when any one of the plurality of moving bodies reaches the destination.

3. The control method according to claim 1, wherein the movement plans are updated when any one of the plurality of moving bodies has passed through any one of the one or more passageways.

4. The control method according to claim 1, wherein the movement plans are periodically updated during movement of the plurality of moving bodies.

5. The control method according to claim 1, wherein the movement plans each are updated to define one or more passageways where each of the plurality of moving bodies passes from a passageway next to a passageway including the current location to the destination so that the plurality of moving bodies does not collide with each other.

6. The control method according to claim 1, wherein in the movement plans, a scheduled time at which each of the plurality of moving bodies enters each of the one or more passageways is defined.

7. The control method according to claim 1, wherein the model is a probability distribution of the delay time.

8. A control device that controls movement of a plurality of moving bodies, the control device comprising:
a processor,
wherein the processor executes:
moving the plurality of moving bodies in accordance with movement plans that have been predetermined, the movement plans defining one or more passageways where each of the plurality of moving bodies passes from a departure place to a destination;
acquiring an actual delay time that is a delay time of each of the plurality of moving bodies, the delay time being generated in each of the one or more passageways;
updating a model representing a length of the delay time defined for each of the one or more passageways using the actual delay time in a corresponding passageway among the one or more passageways;
acquiring a current location of each of the plurality of moving bodies; and
updates each of the movement plans based on the updated model, the destination, and the current location.

9. A non-transitory computer readable storage medium storing a program of a control device that controls movement of a plurality of moving bodies, the program causing the control device to perform operations comprising:
moving the plurality of moving bodies in accordance with movement plans that have been predetermined, the movement plans defining one or more passageways where each of the plurality of moving bodies passes from a departure place to a destination;
acquiring an actual delay time that is a delay time of each of the plurality of moving bodies, the delay time being generated in each of the one or more passageways;
updating a model representing a length of the delay time defined for each of the one or more passageways using the actual delay time in a corresponding passageway among the one or more passageways;
acquiring a current location of each of the plurality of moving bodies; and
updating each of the movement plans based on the updated model, the destination, and the current location.
